(19) United States
(12) Patent Application Publication
(10) Pub. No.: US 2012/0237372 A1
(43) Pub. Date: Sep. 20, 2012

(54) MOTOR-DRIVEN COMPRESSOR AND WIRING METHOD FOR MOTOR-DRIVEN COMPRESSOR

(75) Inventors: Hiroshi FUKASAKU, Kariya-shi (JP); Shinichi OKUYAMA, Kariya-shi (JP); Minoru MERA, Kariya-shi (JP); Hiroshi KOBAYASHI, Kariya-shi (JP); Tatsuya HORIBA, Kariya-shi (JP)

(73) Assignee: KABUSHIKI KAISHA TOYOTA JIDOSHOKKI, Kariya-shi (JP)

(21) Appl. No.: 13/401,112

(22) Filed: Feb. 21, 2012

(30) Foreign Application Priority Data
Mar. 15, 2011 (JP) 2011-056841

(51) Int. Cl. F04B 35/04; H01R 43/00; H02K 3/50

(52) U.S. Cl. 417/410.1; 310/71; 29/872

(57) ABSTRACT

A cluster block is arranged on an outer peripheral surface of a stator core. A lead wire is continuous with a U-phase coil, which extends from a coil end of the stator core, and is then connected to a U-phase connector. A lead wire is continuous with a V-phase coil, which extends from the coil end, and is then connected to a V-phase connector. A lead wire is continuous with a W-phase coil, which extends from the coil end, and is then connected to a W-phase connector. The lead wires are twisted and entwined with one another.

### BACKGROUND OF THE INVENTION

The present invention relates to a motor-driven compressor and a wiring method for a motor-driven compressor.

Japanese Laid-Open Patent Publication No. 11-324920 discloses a motor-driven compressor. The motor-driven compressor includes a contactor attached to the distal end of a lead wire. The contactor is received in a cluster block. A sealed casing has a through hole at a position facing an end surface of a stator. A sealing terminal having a pin is engaged with the through hole in the sealed casing. The pin of the sealing terminal is connected to the contactor in the cluster block. A guide member is attached to the cluster block. The guide member guides the lead wire into the cluster block without bringing the lead wire into contact with an inner wall surface of the sealed casing. The lead wire extends from the end surface of the stator at a position close to the sealed casing.

In contrast, in the configuration disclosed in Japanese Laid-Open Patent Publication No. 2010-59809, the lead wires extend from the end surface of the stator at a position spaced from the sealed casing. This arrangement makes it necessary to increase the length of the lead wires. As a result, in the vicinity of the end surface of the stator from which the lead wires extend, the lead wires may be easily displaced and enter the inner side of the stator. The lead wires thus interfere with a component that is to be mounted in the stator. To solve this problem, as disclosed in Japanese Laid-Open Patent Publication No. 2002-44892, for example, the lead wires may be fixed to coil ends using a binding thread. However, this method decreases work efficiency for assembling the motor-driven compressor.

### SUMMARY OF THE INVENTION

Accordingly, it is an objective of the present invention to provide displacement prevention means for lead wires that improves work efficiency for assembling a motor-driven compressor.

To achieve the foregoing objective and in accordance with a first aspect of the present invention, a motor-driven compressor is provided that includes an outer shell, an electric motor accommodated in the outer shell, a stator core and a plurality of phase coils that configure a stator of the electric motor, a cluster block arranged on an outer peripheral surface of the stator core, a plurality of lead wires, and a displacement prevention means. The lead wires extend from the corresponding phase coils and are connected to connectors in the cluster block. The displacement prevention means prevent the lead wires from displacing to the inner side of the stator core. The at least one of the lead wires crosses one other of the lead wires such that the lead wires restrain each other.

In accordance with a second aspect of the present invention a wiring method for preventing displacement of a lead wire in a motor-driven compressor is provided. The motor-driven compressor includes an outer shell, an electric motor accommodated in the outer shell, a stator core and a plurality of phase coils that configure a stator of the electric motor, a cluster block arranged in the outer shell, a plurality of lead wires that extend from the corresponding phase coils and are connected to connectors in the cluster block, and a displacement prevention means for preventing the lead wires from displacing to the inner side of the stator core. The method includes: a connecting step of connecting the lead wires to the connectors; a twisting step of twisting the lead wires by rotating the cluster block from a first temporary posture, in which the lead wires are connected to the connectors, to a second temporary posture after the connecting step; and an arranging step of arranging the cluster block on an outer peripheral surface of the stator core after the twisting step.

In accordance with a third aspect of the present invention, a wiring method for preventing displacement of a lead wire in a motor-driven compressor is provided. The motor-driven compressor includes an outer shell, an electric motor accommodated in the outer shell, a stator core and a plurality of phase coils that configure a stator of the electric motor, a cluster block arranged in the outer shell, a plurality of lead wires that are extended out from the corresponding phase coils and connected to connectors in the cluster block, and a displacement prevention means for preventing the lead wires from displacing to the inner side of the stator core. The method includes: a braiding step of braiding the lead wires with one another; a connecting step of connecting the lead wires to the connectors; and an arranging step of arranging the cluster block on an outer peripheral surface of the stator core.

### BRIEF DESCRIPTION OF THE DRAWINGS

FIG. 1 is a cross-sectional side view showing a motor-driven compressor according to a first embodiment of the present invention;

FIG. 2 is a cross-sectional view taken along line 2-2 of FIG. 1;

FIG. 3 is an enlarged cross-sectional view showing the vicinity of a stator core of the motor-driven compressor;

FIGS. 4A, 4B, and 4C are plan views illustrating a procedure of twisting a plurality of lead wires together; and

FIG. 5 is a cross-sectional side view showing a motor-driven compressor according to a second embodiment of the present invention.

### DETAILED DESCRIPTION OF THE PREFERRED EMBODIMENTS

### First Embodiment

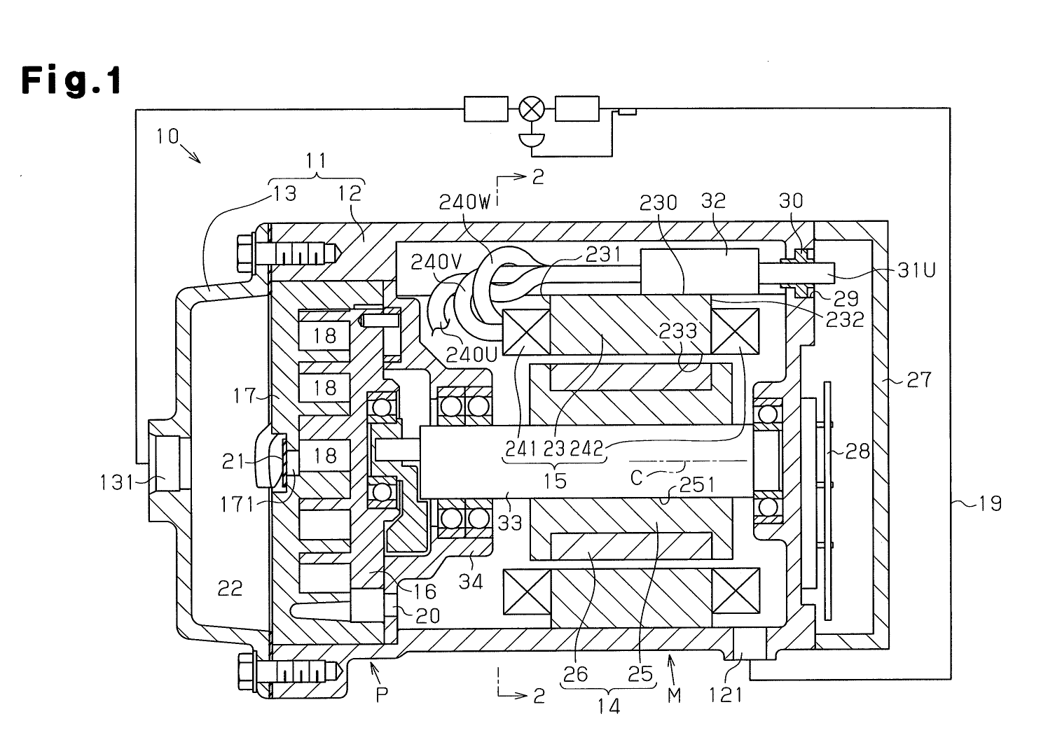

A first embodiment of a motor-driven compressor according to the present invention, which is a scroll type motor-driven compressor, will now be described with reference to FIGS. 1 to 4C.

As shown in FIG. 1, a motor-driven compressor 10 has an outer shell 11 configured by a motor housing member 12 and a front housing member 13. The front housing member 13 is joined with the front end of the motor housing member 12.

An electric motor M has a rotor 14 and a stator 15. The rotor 14 is fixed to a rotary shaft 33. The stator 15 is engaged with and fixed to an inner peripheral surface of the motor housing member 12. A movable scroll 16 is accommodated in the motor housing member 12. The movable scroll 16 can orbit between a fixed scroll 17 and a support block 34. The movable scroll 16 is caused to orbit through rotation of the rotary shaft 33. As the movable scroll 16 orbits, the volume of compression chambers 18, which are defined between the movable scroll 16 and the fixed scroll 17, decreases. The movable scroll 16 and the fixed scroll 17 configure a compression mechanism portion P, which draws and discharges refrigerant.

An inlet port 121 is formed in the motor housing member 12. The inlet port 121 is connected to an external refrigerant circuit 19. Refrigerant gas flows from the external refrigerant circuit 19, proceeds through the inlet port 121, and enters the motor housing member 12. In the motor housing member 12, the refrigerant is drawn into the compression chamber 18 via a passage (not shown) between the inner peripheral surface of the motor housing member 12 and an outer peripheral surface of the stator 15 and a suction port 20 through orbiting motion (suction operation) of the movable scroll 16. The refrigerant in the compression chamber 18 is compressed through orbiting motion (discharge operation) of the movable scroll 16. The refrigerant is then sent from an outlet port 171 into a discharge chamber 22 formed in the front housing member 13 by flexing an outlet valve 21. The front housing member 13 has a discharge port 131. The refrigerant thus flows from the discharge chamber 22 into the external refrigerant circuit 19 via the discharge port 131 and returns to the motor housing member 12.

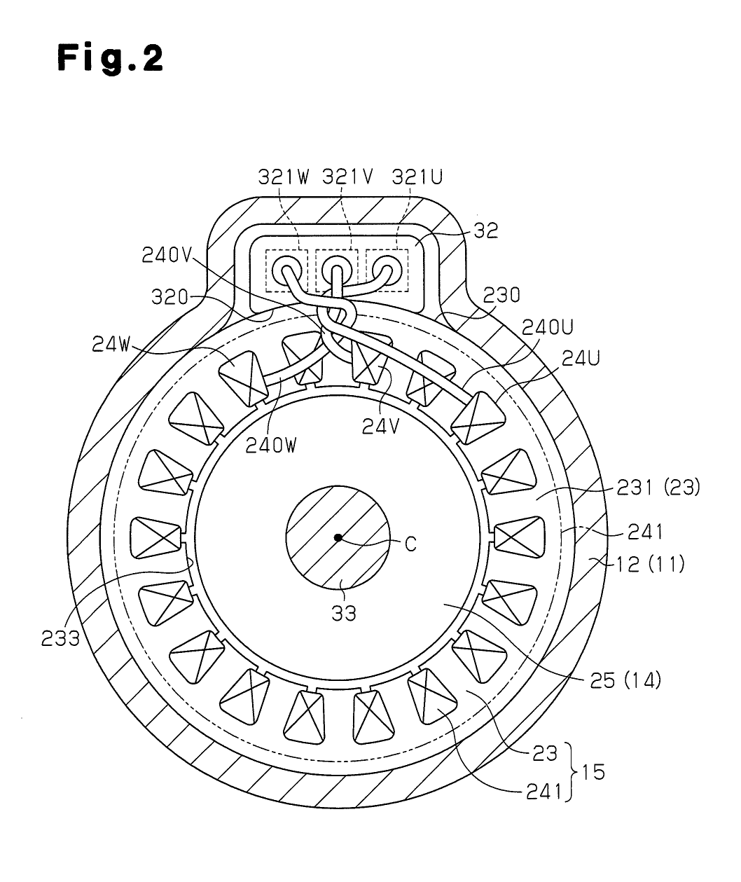

With reference to FIG. 2, the stator 15 has an annular stator core 23. A U-phase coil 24U, a V-phase coil 24V, and a W-phase coil 24W are formed in the stator core 23. Referring to FIG. 1, a coil end 241 is arranged on a front end surface 231 of the stator core 23. A coil end 242 is mounted on a rear end surface 232 of the stator core 23.

As illustrated in FIG. 1, the rotor 14 is configured by a rotor core 25 and a plurality of permanent magnets 26, which are embedded in the rotor core 25. A shaft hole 251 extends through the central portion of the rotor core 25. The rotary shaft 33 is received in and fixed to the shaft hole 251. A cover 27 is fixed to the rear end surface of the motor housing member 12. An inverter 28, which is a drive circuit, is mounted in the cover 27. An insertion hole 29 is formed in the rear end surface of the motor housing member 12, which is covered by the cover 27. A holding tool 30 is engaged with and fixed to the insertion hole 29.

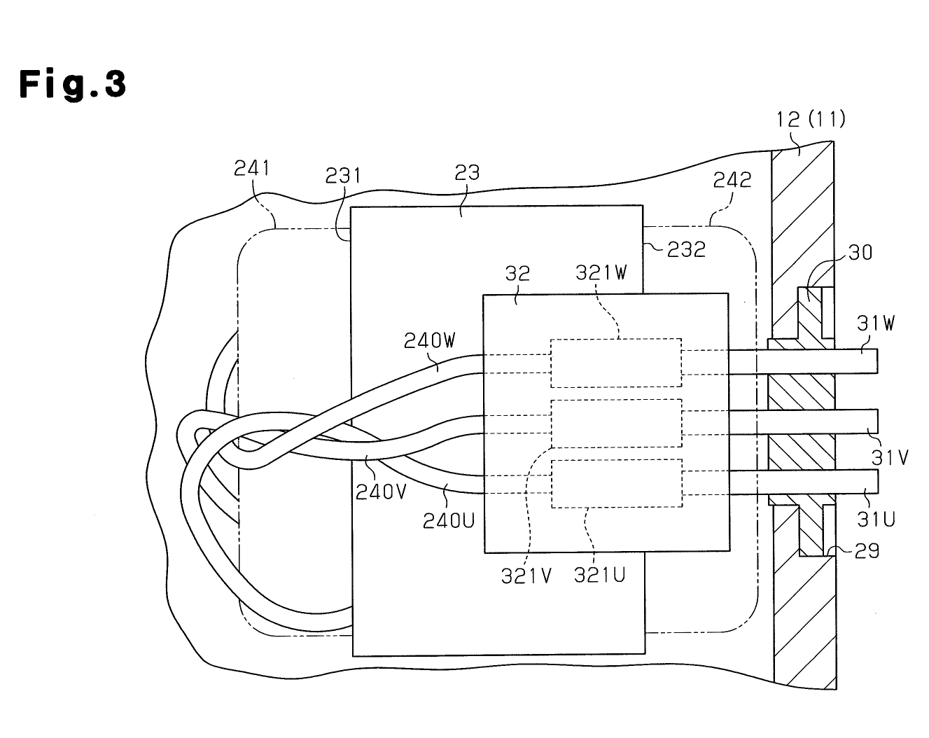

With reference to FIG. 3, a plurality of conductive pins 31U, 31V, 31W are passed through and held by the holding tool 30. In the exterior of the motor housing member 12, the outer end portions of the conductive pins 31U, 31V, 31W are electrically connected to the inverter 28, which is shown in FIG. 1, each through a non-illustrated conductive wire.

With reference to FIGS. 1 to 3, a cluster block 32 is fixed to an outer peripheral surface 230 of the stator core 23. In the cluster block 32, a recess 320 is formed along the outer peripheral surface 230 of the stator core 23, which is a circumferential surface. The cluster block 32 is attached to the outer peripheral surface 230 of the stator core 23 by means of a non-illustrated attachment means.

The cluster block 32 accommodates a U-phase connector 321U, a V-phase connector 321V, and a W-phase connector 321W. The conductive pin 31U is connected to the connector 321U. The conductive pin 31V is connected to the connector 321V. The conductive pin 31W is connected to the connector 321W.

A lead wire 240U is continuous with the U-phase coil 24U, which extends from the coil end 241 of the stator core 23, and is then connected to the U-phase connector 321U. A lead wire 240V is continuous with the V-phase coil 24V, which extends from the coil end 241, and is then connected to the V-phase connector 321V. A lead wire 240W is continuous with the W-phase coil 24W, which extends from the coil end 241, and is then connected to the W-phase connector 321W. The lead wires 240U, 240V, 240W are all coated with a non-illustrated insulating tube. The lead wires 240U, 240V, 240W are twisted with one another. In other words, the lead wires 240U, 240V, 240W are crossed with one another and maintained in a state mutually restraining their postures.

The lead wire 240U and the conductive pin 31U are electrically connected to each other through the U-phase connector 321U. The lead wire 240V and the conductive pin 31V are electrically connected to each other through the V-phase connector 321V. The lead wire 240W and the conductive pin 31W are electrically connected to each other through the W-phase connector 321W.

The motor-driven compressor 10 has the compression mechanism portion P for drawing and discharging refrigerant, the electric motor M, and the inverter 28 serving as the drive circuit for the electric motor M. The compression mechanism portion P, the electric motor M, and the inverter 28 are arranged in series in this order. The lead wires 240U, 240V, 240W extend from the front end surface 231 of the stator core 23 facing the compression mechanism portion P.

Electric power supplied from the inverter 28 is supplied to the coils 24U, 24V, 24W via the conductive pins 31U, 31V, 31W, the connectors 321U, 321V, 321W, and the lead wires 240U, 240V, 240W. This rotates the rotor 14 inside the stator core 23, together with the rotary shaft 33.

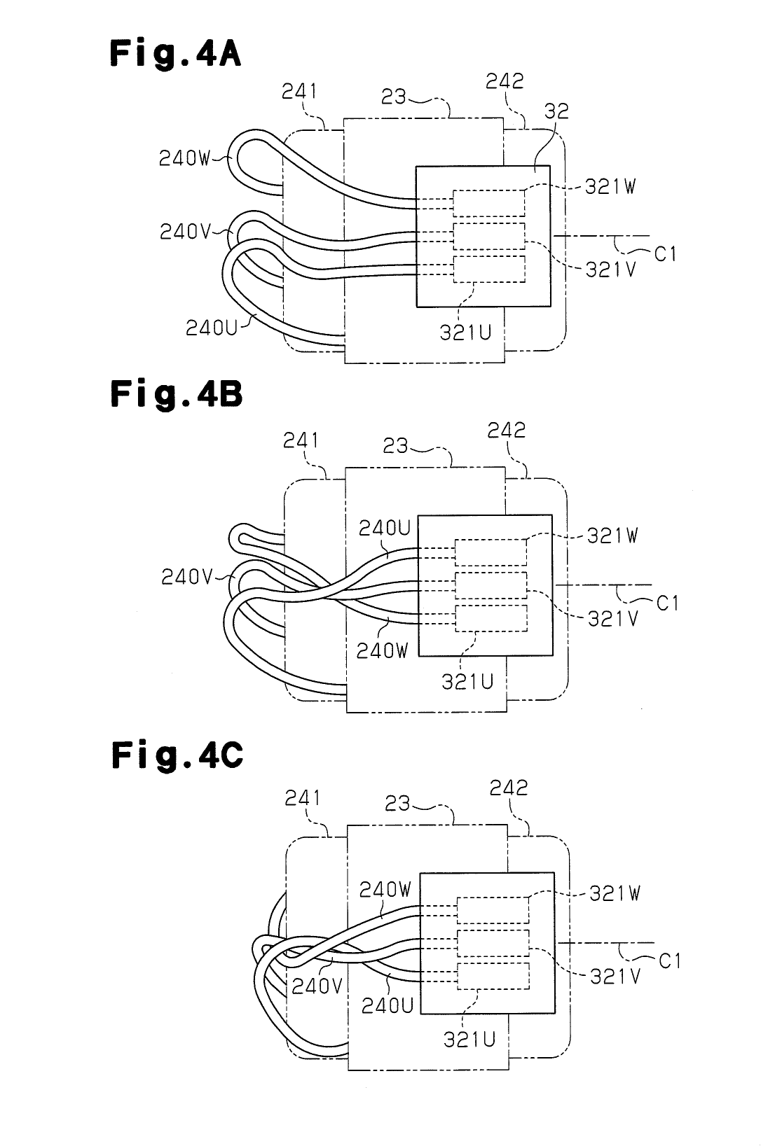

A procedure of twisting and twining the lead wires 240U, 240V, 240W together (a wiring method for preventing displacement of a lead wire) will hereafter be described with reference to FIGS. 4A to 4C.

First in a connecting step, as illustrated in FIG. 4A, the lead wires 240U, 240V, 240W are connected to the corresponding connectors 321U, 321V, 321W. The posture of the cluster block 32 shown in FIG. 4A is a first temporary posture corresponding to the state in which the lead wires 240U, 240V, 240W are connected to the connectors 321U, 321V, 321W.

Following the connecting step, referring to FIG. 4B, the cluster block 32 is rotated from the state of FIG. 4A about the axis C1 by the angle of 180 degrees. The posture of the cluster block 32 shown in FIG. 4B is an intermediate temporary posture. The axis C1 is parallel with the axis C of the rotor 14, which is shown in FIG. 1. The aforementioned rotation changes the posture of the cluster block 32 from the first temporary posture to the intermediate temporary posture and corresponds to a first twisting step for the lead wires 240U, 240V, 240W.

After switching the posture of the cluster block 32 to the intermediate temporary posture, the cluster block 32 is rotated from the state of FIG. 4B about the axis C1 by 180 degrees, as illustrated in FIG. 4C. The posture of the cluster block 32 illustrated in FIG. 4C is a second temporary posture corresponding to the posture of the cluster block 32 illustrated in FIG. 3. The aforementioned rotation switches the posture of the cluster block 32 from the intermediate temporary posture to the second temporary posture and corresponds to a second twisting step for the lead wires 240U, 240V, 240W.

The first twisting step and the second twisting step in combination change the posture of the cluster block 32 from the first temporary posture to the second temporary posture and correspond to a twisting step for the lead wires 240U, 240V, 240W. Following the twisting step, with reference to FIGS. 2 and 3, the cluster block 32 is arranged on and fixed to the outer peripheral surface 230 of the stator core 23 at a predetermined position (an arranging step).

Operation of the first embodiment will now be described with reference to FIGS. 4A to 4C.

As shown in FIG. 4A, the lead wires 240U, 240V, 240W are connected to the corresponding connectors 321U, 321V, 321W in the cluster block 32. The cluster block 32 is then rotated from the state of FIG. 4A about the axis C1 at the angle of 360°. This twists the lead wires 240U, 240V, 240W together as illustrated in FIG. 4C. In this manner, the lead wires 240U, 240V, 240W are stably maintained in a state entwined with one another. As a result, the lead wires 240U, 240V, 240W are prevented from being displaced to the inner side of the stator core 23.

Further, since the lead wires 240U, 240V, 240W extend from the coil end 241, the lead wires 240U, 240V, 240W are prevented from entering the inner side of the stator core 23. The displacement prevention means for preventing the lead wires 240U, 240V, 240W from displacing to the inner side of the stator core 23 crosses at least one of the lead wires 240U, 240V, 240W with another such that the corresponding ones of the lead wires 240U, 240V, 240W restrain each other. In the first embodiment, the displacement prevention means has a twisted configuration in which at least one of the lead wires 240U, 240V, 240W is twisted. Also, in the first embodiment, the displacement prevention means is arranged between the coil end 241 of the phase coils 24U, 24V, 24W, from which the corresponding lead wires 240U, 240V, 240W extend, and the cluster block 32.

The first embodiment has the advantages described below.

(1) The postures of the lead wires 240U, 240V, 240W are maintained by twisting and entwining the lead wires 240U, 240V, 240W with one another. The lead wires 240U, 240V, 240W are thus prevented from entering the inner side of the stator core 23. As a result, a component (which is, for example, the support block 34) is prevented from interfering with a lead wire when installed in a zone in which the lead wire could have easily entered.

(2) The displacement prevention means has the twisted configuration and is easily formed and prevented from displacing. Further, the cluster block 32 is easily rotated to twist the lead wires 240U, 240V, 240W together. As a result, work efficiency for assembling the motor-driven compressor 10 is improved.

(3) Simply by rotating the cluster block 32 by one full turn, the lead wires 240U, 240V, 240W are twined with one another and thus the postures of the lead wires 240U, 240V, 240W are stabilized.

(4) The motor-driven compressor 10 has the compression mechanism portion P, the electric motor M, and the inverter 28. The compression mechanism portion P, the electric motor M, and the inverter 28 are arranged in series in this order. The lead wires 240U, 240V, 240W are extended from the front end surface 231 of the stator core 23 facing the compression mechanism portion P. This arrangement makes it unnecessary to wire the electric motor M and the inverter 28 with each other in a narrow gap between the electric motor M and the inverter 28. In other words, in the first embodiment, winding is performed easily and thus work efficiency for assembling the motor-driven compressor 10 is improved. The narrow gap between the electric motor M and the inverter 28 is the space between the rear end surface 232 of the stator core 23 and the rear end wall of the motor housing member 12.

As a result, according to the present invention, the postures of the lead wires 240U, 240V, 240W are stabilized by twisting the lead wires 240U, 240V, 240W together. Accordingly, the invention is suitable for assembling the motor-driven compressor 10, which is a serially arranged type.

### Second Embodiment

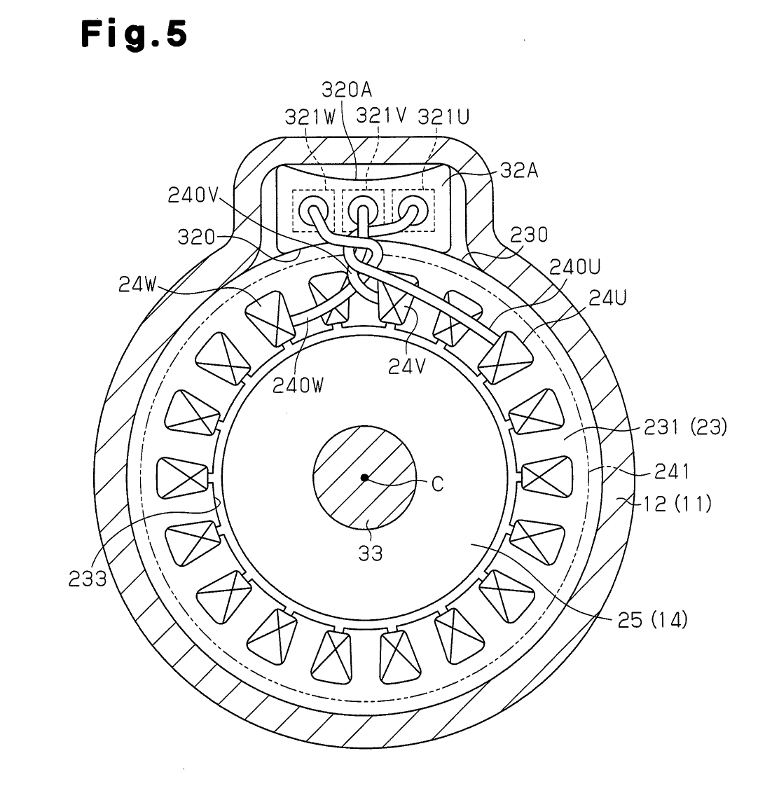

A second embodiment of the present invention will hereafter be described with reference to FIG. 5. Detailed descriptions are omitted for components of the second embodiment that are like or the same as corresponding components of the first embodiment.

FIG. 5 shows a cluster block 32A fixed to the outer peripheral surface 230 of the stator core 23. The cluster block 32A is symmetrical with respect to the axis C1 shown in FIG. 4A. In other words, the cluster block 32 has a pair of opposite surfaces with a recess 320 formed in one of the surfaces and a recess 320A formed in the other surface. The recess 320A is shaped and sized identically with the recess 320. The recess 320A is symmetrical with the recess 320 with respect to the axis C1. When the cluster block 32A is rotated from the state of FIG. 5 by a number of times equal to an integer, the recess 320A is brought into contact with the outer peripheral surface 230 of the stator core 23.

If the cluster block 32A is rotated to twist the lead wires 240U, 240V, 240W by a number of times equal to a half integer, the posture of the cluster block 32A remains the same before and after rotation. As a result, the degree of twisting, which is determined in correspondence with the length of each of the lead wires 240U, 240V, 240W, is finely set compared to the first embodiment.

The first and second embodiments may be modified to the forms described below.

In the first embodiment, the cluster block 32 may be rotated by more than two turns to twist the lead wires 240U, 240V, 240W.

As long as a plurality of lead wires are twisted together to mutually restrain their movement, the cluster block may be rotated by any suitable number of turns or by any suitable angle.

A plurality of lead wires may be braided together to mutually restrain their movement. For example, three lead wires 240U, 240V, 240W may be braided together to restrain movement of the lead wires 240U, 240V, 240W. In this case, a braiding step of braiding the lead wires 240U, 240V, 240W together, a connecting step of connecting the lead wires 240U, 240V, 240W to the corresponding connectors 321U, 321V, 321W, and an arranging step of arranging the cluster block 32 on the outer peripheral surface 230 of the stator core 23 are carried out. This twists and entwines the lead wires 240U, 240V, 240W together and thus maintains the postures of the lead wires 240U, 240V, 240W. In this case, the displacement prevention means is a braided configuration in which the lead wires 240U, 240V, 240W are braided together. The displacement prevention means has the braided configuration and easily formed and prevented from displacing.

A particular one of the lead wires 240U, 240V, 240W may be wound around the rest of the lead wires 240U, 240V, 240W to restrain the postures of the lead wires 240U, 240V, 240W.

The inverter 28 (the drive circuit) may be arranged outside the electric motor M.

1. A motor-driven compressor comprising:
an outer shell;
an electric motor accommodated in the outer shell;
a stator core and a plurality of phase coils that configure a stator of the electric motor;
a cluster block arranged on an outer peripheral surface of the stator core;
a plurality of lead wires, wherein the lead wires extend from the corresponding phase coils and are connected to connectors in the cluster block; and
a displacement prevention means for preventing the lead wires from displacing to the inner side of the stator core,
wherein the at least one of the lead wires crosses one other of the lead wires such that the lead wires restrain each other.

2. The motor-driven compressor according to claim 1, wherein the displacement prevention means is located between end portions of the phase coils from which the lead wires extend and the cluster block.

3. The motor-driven compressor according to claim 1, wherein the displacement prevention means has a twisted configuration in which at least one of the lead wires is twisted.

4. The motor-driven compressor according to claim 1, wherein the displacement prevention means has a braided configuration in which the lead wires are braided together.

5. The motor-driven compressor according to claim 1, wherein the cluster block has a recess held in contact with a peripheral surface of the stator core.

6. The motor-driven compressor according to claim 1, further comprising a compression mechanism portion for drawing and discharging refrigerant and a drive circuit for controlling the electric motor,
wherein the compression mechanism portion, the electric motor, and the drive circuit are arranged in series in this order, the lead wires being extended from coil ends of the phase coils facing the compression mechanism portion.

7. A wiring method for preventing displacement of a lead wire in a motor-driven compressor, the motor-driven compressor including an outer shell, an electric motor accommodated in the outer shell, a stator core and a plurality of phase coils that configure a stator of the electric motor, a cluster block arranged in the outer shell, a plurality of lead wires that extend from the corresponding phase coils and are connected to connectors in the cluster block, and a displacement prevention means for preventing the lead wires from displacing to the inner side of the stator core, the method comprising:
a connecting step of connecting the lead wires to the connectors;
a twisting step of twisting the lead wires by rotating the cluster block from a first temporary posture, in which the lead wires are connected to the connectors, to a second temporary posture after the connecting step; and
an arranging step of arranging the cluster block on an outer peripheral surface of the stator core after the twisting step.

8. The wiring method for a motor-driven compressor according to claim 7, wherein the second temporary posture is a temporary posture where the cluster block has been rotated from the first temporary posture by at least 180°.

9. The wiring method for a motor-driven compressor according to claim 7, wherein the cluster block is symmetrical with respect to an axis that is parallel with the axis of a rotor of the electric motor.

10. The wiring method for a motor-driven compressor according to claim 7, wherein the second temporary posture is a temporary posture where the cluster block has been rotated from the first temporary posture by at least 360°.

11. A wiring method for preventing displacement of a lead wire in a motor-driven compressor, the motor-driven compressor including an outer shell, an electric motor accommodated in the outer shell, a stator core and a plurality of phase coils that configure a stator of the electric motor, a cluster block arranged in the outer shell, a plurality of lead wires that are extended out from the corresponding phase coils and connected to connectors in the cluster block, and a displacement prevention means for preventing the lead wires from displacing to the inner side of the stator core, the method comprising:
a braiding step of braiding the lead wires with one another;
a connecting step of connecting the lead wires to the connectors; and
an arranging step of arranging the cluster block on an outer peripheral surface of the stator core.

12. The wiring method for a motor-driven compressor according to claim 11, the electric compressor further including a drive circuit for controlling the electric motor, the wiring method further comprising a connecting step of connecting conductive pins connected to the drive circuit to the connectors after the arranging step.
